(19) United States
(12) Patent Application Publication
(10) Pub. No.: US 2022/0000127 A1
(43) Pub. Date: Jan. 6, 2022

(54) Novel System and Method for Finishing Cattle for Whole Grind Primal Cut Processing and a Lean Product Produced Thereby

(71) Applicant: Burns Farms LLC, Alpena, AR (US)

(72) Inventor: Billy Jack Burns, II, Alpena, AR (US)

(21) Appl. No.: 17/365,651

(22) Filed: Jul. 1, 2021

Related U.S. Application Data
(60) Provisional application No. 63/046,786, filed on Jul. 1, 2020.

(51) Int. Cl. A22C 17/00; A22B 3/00

(52) U.S. Cl. CPC A22C 17/0026; A22C 17/004; A22B 3/00

(57) ABSTRACT

A novel and sustainable start-to-finish process for producing a premium ground beef product made from whole-ground primal cuts of beef, where the process begins with the cow-calf operation seeing the birthing of a calf at approximately one year prior to the desired date of slaughtering for retail, weaning the birthed calf until the calf is approximately six to nine months old, finishing the calf to the yearling stage (preferably at the main operation but optionally by a stocker/backgrounder), slaughtering the yearling for processing, and processing the yearling by deboning the carcass and whole-grinding the carcass to create a ground beef product that includes a mixture of primal cuts of beef.

### CROSS REFERENCE TO RELATED APPLICATIONS

This application claims priority to U.S. Provisional Patent Application No. 63/046,786, filed on Jul. 1, 2020, and entitled “Sustainable and Renewable Model for Finishing Cattle for Whole Grind Primal Cut Processing.” Such application is incorporated by reference herein in its entirety.

### STATEMENT REGARDING FEDERALLY SPONSORED RESEARCH OR DEVELOPMENT

Not applicable.

### BACKGROUND OF THE INVENTION

The meat and poultry industry is the largest segment of U.S. agriculture. Some statistics show that the U.S. consumption of beef in 2019 amounted to 27.3 billion pounds, with 3.07 billion pounds being imported. Generally speaking, there are three stages of a cattle's life, taking a few years for the beef to go from the farm to the store for purchasing. The first stage is typically the cow-calf segment, which is the period from the calf's birth to weaning (separation from the mother), which typically takes, for example, 6-9 months. The second stage is typically the backgrounding or stocker phase of product, which is when body weight is added to recently weaned calves. The final stage is typically the finishing stage, in which the cattle gains its final weight before slaughter.

Traditionally, cattle do not progress from the stocker phase to the finishing stage until the cattle reach a weight of about 700 to 900 pounds. That is, at age 6-9 months after weaning, the cattle are traditionally finished to yearling age (about 12 months) at a stocker/backgrounder operation. Then, the cattle are transferred to a feedlot for final finishing. Traditionally, the industry projected final finish is based on the amount of fat content in the muscle. That is, the term “finish” in cattle-raising refers to the amount of fat covering (or intermuscular fat) on a market animal carcass. In traditional methods, grain finish of cattle can take 15-18 months while grass finish can take 20-24 months. At that time, the cattle are ready for processing into the meats available for consumers.

But in the United States, the meats processed for consumers is heavily dependent on imported products from foreign sources. Because the traditional U.S. industry process finishes the cattle with intermuscular fat being the priority, most finished cattle will average a 50/50 fat ratio, which is well below the USDA's guidelines of “no more than 30% fat” in ground beef. Thus, the leaner ratios that consumers see at the supermarkets (for example 90/10 lean ground beef) is produced by mixing imported beef cuts or old cow/bulls cuts. In the U.S., ground beef is most generally a byproduct of trimmings from the sub primal cuts, requiring additions of these other meats. On cattle finished according to these industry standards, about 150 lbs of trimmings is average and the only way for it to be used is by mixing in lean meat cuts. The dependency on foreign meat sources is a direct consequence of the finishing model widely and persistently used in the U.S. beef industry. Furthermore, pink slim or lean finely textured beef (LFTB), the meat by-product used as the additive for beef-based processed meats as the filler to reduce the overall fat content of the ground beef, undergoes a mechanical and chemical process that utilizes ammonia gas or citric acid to kill bacteria. While the USDA has approved the product for limited human consumption, the European Union has banned LFTB prepared using ammonia gas.

While this traditional cattle-producing process has been the industry-standard for many years, times are changing and a novel, sustainable process that can shake up the meat industry, and provide relief to small farmers competing with farming megacorporations, is needed. Furthermore, a new model is needed that reduces or entirely eliminates the U.S. beef industry's dependence on foreign meat sources and on processes that require potentially dangerous chemical treatments.

BRIEF SUMMARY OF THE INVENTION

The present invention is directed to a start-to-finish model of cattle producing that uses yearling cattle for whole grind of primal cut processing and to a lean ground beef product produced thereby. The model provides a yearly sustainable and renewable process because age is the determination for finishing not intermuscular fat. Because the process does not rely on intermuscular fat for finishing, cattle farmers are able to achieve a finish product at the yearling age (saving several months over the traditional cattle producing process). This also allows the farmer to produce a ground beef that meets USDA fat ratio requirements and removes the need to mix foreign meats to create a leaner product. Furthermore, a novel approach to processing the cattle is presented, where primal cuts are ground. This not only allows for the year-to-year sustainability, but also produces a leaner ground beef. All of this is achieved by eliminating multiple steps from conventional finishing that add time and uncertainty to the cattle production process. Finally, the ground beef product produced by the method of the present invention is a lean product having no more than 15% fat (e.g. a 85/15lean to fat ratio) without supplementation using imported beef or old meat products.

The present invention presents a novel and sustainable start-to-finish process for producing a premium ground beef product made from whole-ground primal cuts of beef, where the process begins with the cow-calf operation seeing the birthing of a calf at approximately one year prior to the desired date of slaughtering for retail, weaning the birthed calf until the calf is approximately six to nine months old, finishing the calf to the yearling stage (preferably at the main operation but optionally by a stocker/backgrounder), slaughtering the yearling for processing, and processing the yearling by deboning the carcass and whole-grinding the carcass to create a ground beef product that includes a mixture of primal cuts of beef.

These and other features, objects and advantages of the present invention will become better understood from a consideration of the following detailed description of the preferred embodiments in conjunction with the drawings as described following:

### BRIEF DESCRIPTION OF THE DRAWINGS

FIG. 1 is a flow chart showing one embodiment of the process of the present invention.

FIG. 2 is a flow chart showing the traditional industry standard process for raising cattle to finish and producing cuts of meat from said cattle.

### DETAILED DESCRIPTION OF THE INVENTION

Generally speaking, the present invention is directed to a system and method for raising cattle for slaughter and meat production, the method providing a sustainable and renewable cattle-producing process, that allows for a naturally produced leaner mixture that eliminates the need to mix other beef (such as imported beef). Further, no chemical process is needed. Generally speaking, the method of the present invention improves traditional cattle-producing by modifying the finishing stage of cattle-producing by measuring finish readiness by cattle age instead of intermuscular fat, allowing farmers to eliminate some of the time-consuming and time-uncertain steps of traditional cattle finishing. Furthermore, after slaughter, the process presents a unique meat processing step that grinds primal cuts, allowing for the production of a naturally lean meat with a unique taste and texture profile.

Having described the invention generally, the method for raising cattle for slaughter and meat production may now be described. Of course, the method begins at the beginning of the cattle's life cycle—birth 3a—with the cow-calf stage of the operation 3. This cow-calf stage 3 involves keeping mature cattle to produce calves to sell to other farmers or to raise for slaughter. Generally speaking, cows are bred to have a calf every year, usually in late winter or early spring. In one embodiment of the present invention, multiple cows may be bred at different times, to allow for the birthing 3a of calves at different times throughout the year. Because the present invention calls for finishing 5 calves at the yearling stage (approximately one-year after birth), as described more fully below, staggering the birth 3a of calves throughout the year allows for finishing 5 of (and thereafter, slaughtering 7 and processing 9 of) yearlings throughout the next year, which can provide a steady and predictable schedule of finishing 5, slaughtering 7, and processing 9 for the cattle farmer. While traditional breeding and birthing methods can be used to facilitate the birthing 3a of new calves, because the method of the present invention relies heavily on age and timing for finishing 5, it may be seen that the timing and scheduling of calf births 3a is of greater importance for the present invention than traditional cattle raising methods, which do not care about age as much as they care about weight (and how much fat) of cattle. In this regard, if a cattle farmer anticipates the need to have cattle available for slaughtering 7 and processing 9 at a particular time in the future, cows should be bred 3a so that the birth 3a of the calf is expected one-year prior to that time. While gestation length for cattle varies by breed and self of the calf, on average the gestation period for cattle is about 283 days, so for a farmer anticipating slaughtering 7 and processing 9 on a particular day in the future, the cattle should be bred 3a approximately 1 year and 283 days in advance, allowing for the gestation period, the birth 3a of the calf, and one-year of aging before the slaughtering 7 and processing 9 occurs.

After birth 3a, the calves preferably remain with their mothers and go through the weaning process 3b of the cow-calf operation until they are six months to about nine months old. Weaning 3b is the process of gradually separating the calf from its mother, doing so in a way to eliminate as much stress as possible, from both the mother and the calves. Weaning 3b to eliminate stress from the mother's life, allows the mother to regain her condition after weaning 3b, enabling her to be bred for birthing 3a of new calves again (thus, restarting the entire process of the present invention). There are many methods that can be utilized for weaning, 3b including, for example, keeping the calves in a well-fenced area and removing the cows (i.e. the calves' mothers) to a distant area, preferably out of earshot of the calves, exchanging calves between two different herds (allowing the calves to have the company of other cows who are not the calves' mothers), and other similar methods. In some cases, a few dry cows can be kept with the calves in order to calm the calves as much as possible. Alternatively, weaning 3b can be done naturally, allowing the mother cow to naturally decide when the wean her own calf. The weaning process 3b can, generally, take days to weeks, depending on the age at which the calves are weaned and the breed of the cow.

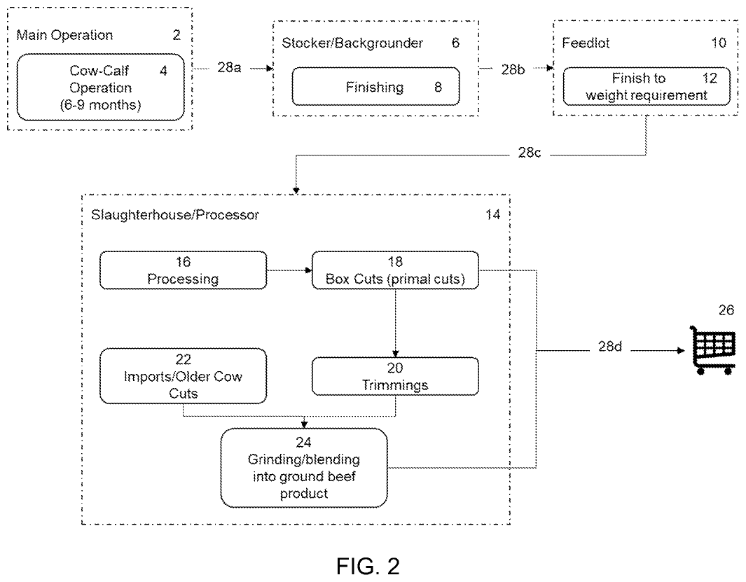

In the present invention, once weaned 3b, the calf is ready for finishing 5. Finishing 5 is the period after weaning 3b when cattle are developed to reach the defined threshold for slaughtering 7. In traditional cattle raising processes, as shown for example in FIG. 2, after weaned during the traditional cow-calf operation techniques 4, cattle are sold to a stocker or backgrounder 6 who finishes 8 the calves until they are about one year old—calves at this age are called “yearlings.” At this point in the traditional processes, the yearlings are then shipped off 28b to a feedlot 10 for additional finishing 12, because fat of the calf is the threshold for slaughtering 14. In fact, according to traditional industry standards, the yearlings are too old to be considered veal (which is classified as 600 lbs or less by the USDA) but they are too young to have the intermuscular fat necessary to be considered “finished” by current industry standards. Thus, cattle farmers utilizing the traditional method need to add finish to the cattle at a feedlot 10 to meet the industry standards on finishing 12. This usually takes an additional 5-7 months in a traditional feedlot setting 10 and even longer, an additional 12-14 months, in grass-fed only operations. Meaning that when using the traditional cattle raising techniques the cattle are not ready for slaughter 14 until they are 18 to 24 months old, at which point they are shipped off 28c again for slaughtering 14 and remaining processing 16. This traditional process, as shown in FIG. 2, introduces a lot of uncertainly for farmers. For example, because farmers must wait until the cattle have gained enough intermuscular fat, there may be times when a farmer does not have a sufficient amount of cattle to slaughter, thus limiting the amount of meat the farmer has to sell at that time. Furthermore, because in the traditional model the time it takes for each individual cattle to reach the appropriate fat/weight finish will differ from cattle to cattle, there is no certainty as to when cattle will be ready for slaughter, further hindering a farmer's ability to plan on a year-to-year basis. Further, a lot can happen in those years that introduce a lot of risk in the raising of cattle. For example, if disease or natural disaster(s) occur that wipe out entire herds of cattle, the farmer may be left with no remaining cattle to sell for slaughter and processing, ultimately losing out on a lot of revenue for the farmer's operation.

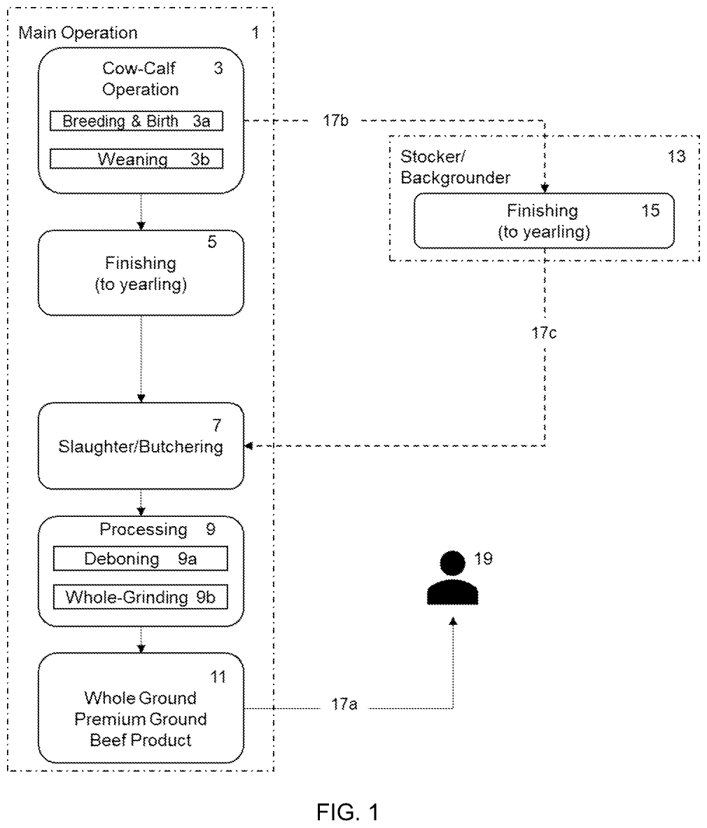

For these reasons, the present invention, as shown in FIG. 1, defines the slaughtering 7 threshold based on the age of the cattle and not the weight, fat, or muscle. That is, after weaning 3b, the method of the present invention finishes 5 the cattle until the yearling stage, and, instead of sending the cattle to a feedlot for additional finishing to reach a certain weight or fat finish (or otherwise doing any additional finishing of the cattle to reach a certain weight or fat finish), according to the method of the present invention, the cattle have met the slaughtering 7 threshold when the reach the yearling stage. In this regard, after weaning 3b, which preferably occurs at about 6 to 9 months of age, the finishing 5 of the present invention preferably takes about 3 to 6 months (depending on the age weaning occurs), instead of several years. The finishing 5 of the present invention can be performed by the farmer themselves at the main operation 1 or the weaned 3b cattle can be sent 17b to a stocker/backgrounder 13 for finishing 15 to the yearling stage. In any event, it may be seen that according to the present invention, cattle are “finished” and ready for slaughter 7 at a defined age, regardless of the amount of intermuscular fat present. Preferably, the main operation 1 finishes 5 the cattle to the yearling stage, eliminating the need to ship 17b the cattle to a stocker/backgrounder 13 (and in most cases ship 17c the cattle again for slaughtering/butchering 7), which reduces the carbon footprint of the cattle raising process. Furthermore, because it's not necessary to use backgrounder or stocker or feedlot operations used in the traditional method of cattle-raising, the cattle can be kept on the farm where they were born—allowing the cattle to be raised on pasture and never in confinement feeding situations. This is not only a more humane method for raising the cattle, but cuts-out the middle man for many small farmers. Still, even if a backgrounder or stocker 13 operation is used, it's preferable to finish 15 the cattle to yearling on pasture and never in a confinement feed situation. Furthermore, the cattle can be grass finished with no grains, grass finished with grain supplements, raised with or without antibiotics, and raised with or without vaccines, allowing individual farmers work according to their own desired management practices. In any event, the crux of the present invention is that the cattle are finished and ready for slaughter at the yearling stage.

At this point, the point where the cattle has been finished 5 to the yearling stage, the unique meat processing 9 aspect of the present invention is implemented. Because the industry traditionally uses intermuscular fat content as the target for finish, the current industry standard processing 16 is useful for maximizing high end retail sub primal cuts 18 of meat. The trimmings 20 from these primal cuts 18, when using the traditional method of cattle raising as shown in FIG. 2, are then added to imported meats or older cow cuts 22 to create the ground beef product 24 seen in many retail stores 26 today. Of course, as noted above, a yearling is too young to have the intermuscular fat necessary to be “finished” according to those traditional standards. That's why the method of the present invention, as shown in FIG. 1, introduces the steps of deboning 9a and whole grinding 9b primal cuts of yearling animals as a premium ground beef alternative 11. Whole grinding 9b has not been used in the beef industry because of the input cost and the return of a lower price product. However, with the grinding 9b of all primal cuts from the finished yearlings, the model of the present invention produces a leaner ground beef 11 (and as noted, achieves a year-to-year sustainable rotation of cattle for slaughter). The ground beef 11 also has a unique taste and texture profile because it contains all the primal cuts, including filet mignon, New York strip steak, and ribeye. The whole grinding 9b of the yearling cattle according to the method of the present invention has been found to provide a lean product 11 having a percentage fat generally no higher than 15%, and it has been found that it is possible, even, to provide a lean product having as little as 4% fat without requiring the supplementation using imported beef. In this regard, the present invention is capable of producing lean products with lean-to-fat ratios of 96/4, 93/7, 95/5, 90/10, and 85/15, all without supplementing with outside beef sources.

The cattle raising method of the present invention not only produces lean ground beef products 11, but removes many of the energy dense steps out of cattle-raising operations. For example, while traditional cattle-raising operations requiring the cattle to be shipped as many as 4 times (for example, shipped 28a from the main operation 2 to the backgrounder 6, shipped 28b from the backgrounder 6 to the feed lot 10, shipped 28c from the feedlot 10 to slaughter 14, and finally shipped 28d to retail 26), the present invention can have as little as a single shipping requirement (for example, shipping 17a from the main operation 1 that self-finishes 5 the cattle to yearling stage and self-processes 9 the cattle by whole-grinding 9b to the consumer 19)—drastically reducing the carbon footprint of the operation. Furthermore, the method allows for an increased stocking density per acre of farmland, even allowing as much as twice as many animals to be processed versus traditional grass finish operations. In a world where sustainability is an ever increasing concern and where there may be an ability to secure carbon credits or carbon offsets for sustainable operations, the method of the present invention introduces another valuable aspect to the farmer's cattle operation, allowing for carbon offsets to be sold as readily as the tangible beef product itself.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A method for producing a ground beef product, the method comprising the steps of:
a. facilitating the birth of a calf;
b. after the birth of the calf and when the calf reaches a weaning age, weaning the calf;
c. after the calf is weaned, finishing the calf until the calf reaches approximately one year of age;
d. after the calf reaches approximately one year of age, slaughtering the calf; and
e. processing the slaughtered calf, wherein processing the slaughtered calf comprises the steps of:
i. deboning the slaughtered calf to produce a beef carcass comprising a plurality of primal cuts; and
ii. whole-grinding the beef carcass to produce the ground beef product.

2. A method for raising cattle for production of a premium ground beef blend, the method comprising the steps of:
a. facilitating the birth of a calf;
b. after the birth of the calf and when the calf reaches a weaning age, weaning the calf, wherein the weaning age is when the calf is no younger than six months of age and no older than nine months of age;
c. after weaning the calf, finishing the calf until the calf becomes a yearling;
d. when the calf becomes a yearling, preparing the ground beef blend, wherein preparing the ground beef blend comprises the steps of:
i. slaughtering the yearling to produce a beef carcass;
ii. deboning the beef carcass; and
iii. whole-grinding the beef carcass.

3. A premium ground beef blend comprising a mixture of ground primal cuts of beef produced by whole-grinding a carcass of yearling calf.
